(19) United States
(12) Patent Application Publication
(10) Pub. No.: US 2024/0175152 A1
(43) Pub. Date: May 30, 2024

(54) SEPARATOR PLATE FOR AN ELECTROCHEMICAL SYSTEM, COMPRISING TWO DIFFERENT INDIVIDUAL PLATES

(71) Applicant: Reinz-Dichtungs-GmbH, Neu-Ulm (DE)

(72) Inventors: Wilhelm KUHN, Tomerdingen (DE); Johann WALDVOGEL, Krumbach (DE); Oliver CLAUS, Laichingen (DE); Franz SCHWEIGGART, Pfaffenhofen (DE); Stefan WENZEL, Pfaffenhofen (DE)

(21) Appl. No.: 18/517,564

(22) Filed: Nov. 22, 2023

(30) Foreign Application Priority Data
Nov. 25, 2022 (DE) 20 2022 106 613.2

(51) Int. Cl. C25B 13/02; C25B 9/23; C25B 11/032; C25B 13/05

(52) U.S. Cl. CPC C25B 13/02; C25B 9/23; C25B 11/032; C25B 13/05; H01M 8/0206

(57) ABSTRACT

A separator plate, an assembly for an electrochemical system, and an electrochemical system, the separator plate comprising a first metal plate, the first plate having a flow field with channel structures integrally formed in the first plate for guiding a reaction medium or product medium along the first plate. A second metal plate having at least one sealing element for sealing off at least one region of the separator plate. The first plate and the second plate differ from each other in at least one material property and/or in their material thicknesses and the first plate and the second plate are connected to each other in a materially bonded manner.

### CROSS-REFERENCE TO RELATED APPLICATION

The present application claims priority to German Utility Model Application No. 20 2022 106 613.2, entitled “SEPARATOR PLATE FOR AN ELECTROCHEMICAL SYSTEM, COMPRISING TWO DIFFERENT INDIVIDUAL PLATES”, and filed Nov. 25, 2022. The entire contents of the above-listed application is hereby incorporated by reference for all purposes.

### TECHNICAL FIELD

The present disclosure relates to a separator plate for an electrochemical system, said separator plate comprising two individual plates which are connected to each other. The electrochemical system may be an electrolyser.

### BACKGROUND AND SUMMARY

Electrolysers produce, for example, hydrogen and oxygen from water by applying a potential and may at the same time compress at least one of the gases produced.

Conventional electrolysers consist of a stack of individual cells which each comprise a sequence of layers including a separator plate, two media diffusion structures, such as porous transport layer(s) (PTL(s)) and/or gas diffusion layer(s) (GDL(s)), and a membrane electrode assembly (MEA). This stack of electrochemical cells must be sealed off with respect to the exterior since the media are guided within the cells at an overpressure relative to the exterior pressure. To this end, electrolysers typically have, for each of the individual electrochemical cells stacked one above the other to form an electrolyser, a cell frame extending around the outer edge of the electrochemical cell. The individual cells in the stack are compressed together, for example by means of screws, between two end plates. Between the individual cell frames and between the cell frames and the separator plates or membrane electrode assemblies arranged between the cell frames, the stack of electrochemical cells has sealing elements extending circumferentially along the outer circumference, but at a distance inwards from the outer circumference.

The individual cells combined to form the stack are each separated by a separator plate, which serves on the one hand to separate the media and on the other hand to transmit the current or voltage from individual cell to individual cell, for instance by virtue of the webs between the fluid-guiding channels being in contact (possibly indirectly) with the MEAs. The separator plates have on their surface a flow field with channel structures which are arranged to supply and discharge fluid. The channel structures have the task of ensuring that media are distributed across the surface.

In an electrolyser, a pressure difference between the surrounding environment and the interior of an electrochemical cell may be more than 20 bar. For example, the pressure on the product side, for example the H₂ side, may be up to 40 bar, while the pressure on the reactant side, for example the H₂O side, is only up to 2 bar. It is therefore important to seal off the flow field with respect to the surrounding environment and also within the electrochemical system. To this end, a scaling element arranged around the flow field is usually provided.

The channel structures of the flow field are usually integrally formed in the separator plate, for example by means of embossing, hydroforming or deep-drawing. To enable good formability of the separator plate, to prevent too much stress on the material of the separator plate during the forming process and to avoid cracks in the material, the channel structures should not be too high and the material in the region of the flow field should not be too thick. Furthermore, the material in the flow field should be corrosion-resistant in order to be able to withstand the aggressive process conditions in the electrochemical system.

Outside of the flow region, the requirements in terms of corrosion resistance are not as high. On the other hand, the system should have a high degree of mechanical stability and a high degree of leaktightness in the outer region.

The material and properties of the separator plate are thus selected as a compromise between formability, corrosion resistance, mechanical stability and sealing effect. This often leads to the separator plate being of non-optimal design in some regions.

Another possibility consists in using a separate cell frame arranged around the flow field of the separator plate, this cell frame being used to seal the system, while the separator plate having the channel structures is responsible for guiding the media along the flat side of the separator plate. In this case, the separator plate is often inserted as an insert part into the cell frame. One disadvantage of these arrangements is that the use of an additional cell frame is relatively complex and laborious. For example, it must be ensured that the cell frame and the separator plate are also connected to each other in a fluid-tight manner, which often requires additional seals. This may be the case in electrolysers, where there are significant differences in pressure between the high-pressure side and the low-pressure side.

The present disclosure has been designed to find the simplest possible practical solution to the above problems.

The present disclosure is defined by the separator plate, the assembly and the electrochemical system according to the independent claims. Further developments will be described in the dependent claims and in the description below.

According to a first aspect, a separator plate for an electrochemical system, for instance an electrolyser, is proposed. The separator plate comprises a first metal plate, the first plate having a flow field with channel structures integrally formed in the first plate for guiding a reaction medium or product medium along the first plate, and a second metal plate having at least one sealing element for sealing off at least one region of the separator plate.

The first plate and the second plate differ from each other in at least one material property and/or in their material thicknesses. Furthermore, the first plate and the second plate are connected to each other in a materially bonded manner.

In other words, the first plate is designed as a flow plate and its primary function is to guide the media along the separator plate. The second plate is designed as a sealing plate and its primary function is to seal off a region of the separator plate with respect to the surrounding environment. With the proposed separator plate, sealing and media guidance are thus effected by two different plates having different material properties and/or material thicknesses. As a result, the first plate can be optimized for media guidance and the second plate can be optimized for sealing.

Said material property may comprise a modulus of elasticity, a strength, an electrical conductivity, a corrosion resistance, an elongation at break and/or a chemical composition.

The different material properties may result from the use of different materials. Alternatively, if the material is the same, the different material properties may result from a different processing of the material. If the main component of the material is the same, the composition of the alloy may be modified by adding at least one further material in order to obtain the different material properties. For instance, pure titanium is typically relatively soft, but harder properties can be achieved by adding further metals to the alloy. The main component of the material means, for example, that at least 50% or at least 70% of the material consists of a single component.

By way of example, one embodiment of the present disclosure may allow the use of a first plate made of titanium having a high elongation at break of 35% and a low strength of 300 MPa as the flow field and, with this, a second plate likewise made of titanium having a low elongation at break of 15% and a high strength of 650 MPa as the plate having a sealing element.

It may be provided that a material thickness of the first plate is between 0.1 and 0.6 mm. A plate thickness of the second plate may be between 0.1 and 1.2 mm. For instance, it may be the case that the second plate has a greater material thickness than the first plate, for example at least two times greater or at least three times greater.

In some embodiments, a plate body of the first plate is made of stainless steel or titanium. A plate body of the second plate may likewise be made of stainless steel or titanium. Combinations of the aforementioned materials and the different thicknesses are possible. The first plate and/or the second plate are often formed from a sheet of metal. For example, the first plate may be made of titanium with good formability, and the second may be made of stainless steel with spring properties. The metal plate body of the first plate and/or of the second plate may be provided with a coating, for example to improve the conductivity, the corrosion resistance or the microsealing effect.

The sealing element often comprises a sealing bead integrally formed in the second plate, or an elastomer bead or coating bonded to the plate body of the second plate. The scaling element usually extends around the region of the separator plate that is to be sealed off. The sealing element is usually designed to seal off the flow field and/or media inlets or media passages. If the sealing element is designed to seal off the flow field, the sealing element may be arranged around the flow field, for example in a frame-like manner. The second plate may also have two scaling elements, which are arranged on both sides of a flat surface plane of the second plate and point away from each other and may possibly have different properties.

In one embodiment, the first plate and the second plate overlap in the region of the channel structures of the first plate. In this case, the second plate may be a continuous, closed plate at least in the region of overlap with the first plate. Optionally, the second plate is designed substantially as a flat plate at least in the region of overlap. The second plate may have a border region which extends around the circumferential edge of the first plate, wherein the sealing element is arranged in the border region. The border region may be frame-like.

In some embodiments, a cavity is defined between the first plate and the second plate in the region of the flow field, wherein pressure-equalizing openings are provided in the channel structures in order to fluidically connect the cavity to a side of the first plate facing away from the second plate. As a result, pressure differences can be equalized.

In a further embodiment, the separator plate comprises a third metal plate which has a flow field with channel structures for guiding a product medium or reaction medium along the third plate, wherein the second plate is arranged between the first plate and the third plate. The separator plate may therefore be designed as a three-layer structure.

The third plate and the second plate often differ from each other in at least one material property and/or in their material thicknesses. Optionally, the third plate and the second plate are connected to each other in a materially bonded manner. It may be provided that the first plate, the second plate and the third plate are jointly welded to each other at least at one location. Alternatively, the materially bonded connections, e.g. the materially bonded connection of the first plate to the second plate and the materially bonded connection of the second plate to the third plate, may also be arranged at a distance from each other.

The first plate and the third plate may be made of the same material and/or may have the same material thickness. The first plate and the third plate may be designed and arranged symmetrically to each other in relation to a flat surface plane of the second plate.

According to another variant, it is provided that the first plate and the second plate do not overlap in the region of the channel structures of the first plate. In this case, the second plate may be frame-like and the first plate may terminate in the outward direction at its circumferential edge. The first plate may be inserted into the frame-like second plate. If present, a region of overlap of the two plates is thus formed without any channel structures in the first plate. Optionally, the first plate and the second plate are materially bonded, for example welded or soldered, in an abutting or overlapping manner, e.g. in the region of overlap.

Regardless of whether or not the first plate and the second plate overlap in the region of the channel structures, the second plate may have a depression, wherein the first plate is connected to the second plate in the region of the depression.

Usually, the first plate and the second plate are welded to each other, for example by means of spot welding, friction welding, roller welding, ultrasonic welding, electrode welding or laser welding. For example, a weld seam may be considered as a materially bonded connection of the plates. Optionally, the first plate and the second plate may be sealingly connected to each other, such as by way of a continuous, e.g. uninterrupted weld seam. As a result, there is no need for additional sealing elements such as sealing layers, which therefore simplifies the system. Similar welded joints may be considered for connecting the second plate and the third plate.

The flow field of the first plate often forms a support surface for a membrane electrode assembly of an electrochemical cell. Analogously, the flow field of the third plate may form a support surface for a membrane electrode assembly of an electrochemical cell. The membrane electrode assembly may be directly arranged on the respective flow field and bear against the latter. e.g. without any elements therebetween. Alternatively, the membrane electrode assembly may also be indirectly arranged on the flow field, wherein a further layer, such as a media diffusion structure, is arranged between the flow element and the membrane electrode assembly. The separator plate may also have at least one through-opening, which is designed for the passage of a reaction medium (reactant medium) or product medium. The through-opening may form a supply opening or a discharge opening. The through-opening may be fluidically connected to the flow field so that a medium can be routed from the through-opening towards the flow field, or away from the flow field to the through-opening.

The separator plate may be designed as a bipolar plate. In other words, in a stack of electrochemical cells connected in series, the separator plate may form at one side the anode of a first electrochemical cell and at the other side the cathode of a second electrochemical cell adjacent to the first electrochemical cell.

According to another aspect, an assembly for an electrochemical system is proposed, comprising a separator plate of the type described above, a membrane electrode assembly (MEA) arranged on the flow field side of the first plate, and/or a porous transport layer (PTL) or gas diffusion layer (GDL) arranged between the MEA and the flow field.

The assembly may further comprise a cell frame which is arranged around the first plate and is arranged on the sealing element of the second plate.

According to another aspect, an electrochemical system is proposed, comprising a plurality of stacked separator plates of the type described above or a plurality of assemblies of the type described above.

The electrochemical system may be, for example, an electrolyser. However, the present specification is not limited to an electrolyser. The electrochemical system may alternatively also be a fuel cell system or a redox flow battery. In an exemplary embodiment in which the electrochemical system is an electrolyser, water is often the reaction medium, while hydrogen or oxygen may be the product medium. In a fuel cell system, hydrogen and oxygen are often the reaction media, while water is the product medium.

Exemplary embodiments of the separator plate, the assembly and the electrochemical system are shown in the accompanying figures and will be explained in greater detail in the description below.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an exploded view of an individual cell of an electrolyser, comprising a separator plate according to the present disclosure.

FIG. 2 shows a perspective view of a separator plate of the individual cell according to FIG. 1.

FIG. 3 shows a plan view of a further separator plate according to one embodiment.

FIG. 4 shows a sectional view of an assembly comprising a separator plate and a cell frame.

FIG. 5 shows a sectional view of a further assembly comprising a three-layer separator plate and two cell frames.

FIG. 6 shows a plan view of a further separator plate according to one embodiment.

FIG. 7 shows a sectional view of a further assembly comprising a separator plate and a cell frame.

FIG. 8 shows a sectional view of a further assembly comprising a separator plate and a cell frame.

FIG. 9 shows a sectional view of a further assembly comprising a separator plate and a cell frame.

FIG. 10 shows a sectional view of a further assembly comprising a separator plate and a cell frame.

### DETAILED DESCRIPTION

Here and below, features that reoccur in different figures are denoted in each case by the same or similar reference signs.

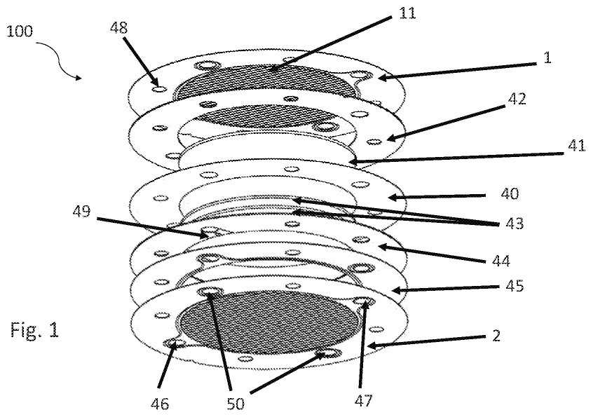

FIG. 1 shows an exploded view of an electrochemical individual cell 100, wherein in the exemplary embodiment shown the individual cell 100 is part of an electrolyser. The individual cell 100 comprises two separator plates 1 and 2, two cell frames 42 and 44, a sealing layer 45, and a membrane electrode assembly 40 with media diffusion structures 41 and 43. For example, the media diffusion structure 43 comprises layers of carbon fleece, while the media diffusion structure 41 comprises metal, e.g. titanium. Here, the separator plate 1 is arranged, for example, on the anode side of the individual cell 100. In the exemplary embodiment shown, the separator plate 2 is arranged on the cathode side of the individual cell 100. The individual layers are compressed together to form an individual cell. The individual layers each have fluid passages 46, 47, 50, arranged in alignment one above the other, for the inward and outward passage of water, oxygen and hydrogen, as well as positioning holes 48.

A flow field of the separator plate 2 is defined by projecting the cell frame 44 onto the separator plate 2. A flow field 11 of the separator plate 1 is defined by projecting the cell frame 42 onto the separator plate 1. The cell frame 42 has distribution channels (not shown) for distributing the water that is fed in. The through-openings 46, 47 are fluidically connected to the flow field 11 so that a medium can be routed from the through-opening 46 to the flow field 11, or from the flow field 11 to the through-opening 47. When a potential is applied, hydrogen can be produced in the electrolyser from the water that has been fed in. Said hydrogen can be discharged through the distribution channels 49 in the cell frame 44. It can then leave the cell through the through-openings 50.

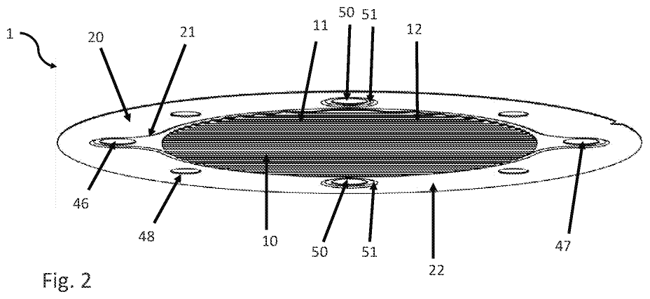

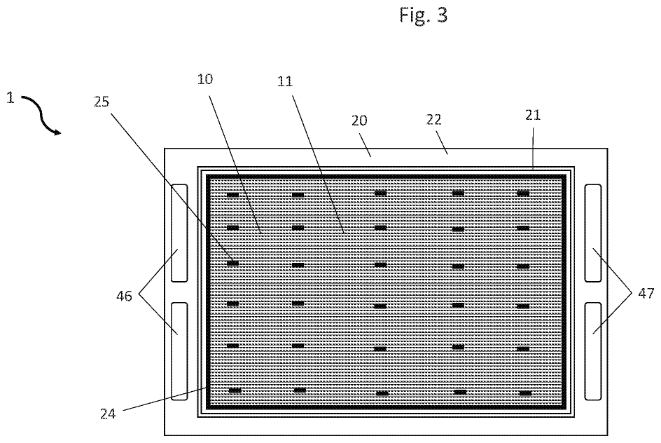

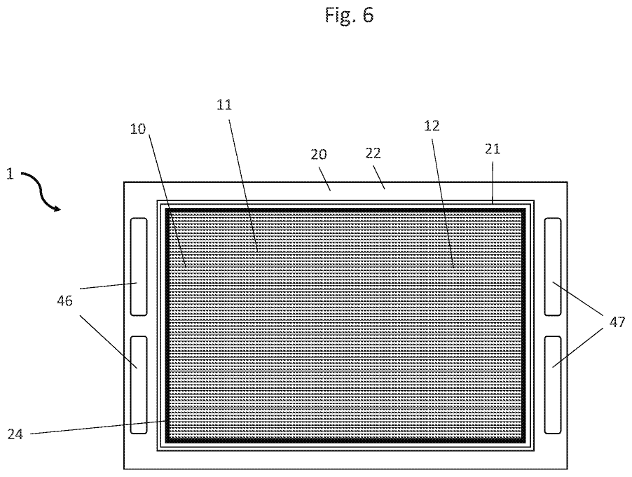

In FIG. 2, the separator plate 1 of FIG. 1 is shown on its own for the sake of clarity and in a perspective view. FIGS. 3-10 show further embodiments of the separator plate 1. While the separator plate 1 shown in FIGS. 1-2 has a round outer contour, other shapes are also possible. For example, the separator plates 1 of FIGS. 3 and 6 have a rectangular outer contour.

Details of the separator plate 1 will be discussed in greater detail below, it being clear that the following description can also apply to the separator plate 2. For instance, the separator plates 1, 2 may be identical.

As can be seen from FIGS. 1-10, the separator plate 1 comprises a first metal plate 10, which 10 has a flow field 11 with channel structures 12 integrally formed in the first plate 10 for guiding a reaction medium or product medium along the first plate 10. The first plate 10 is therefore designed as a flow plate and its primary function is to guide the media along a flat side of the separator plate 1.

The separator plate 1 additionally comprises a second metal plate 20 having at least one sealing element 21 for sealing off at least one region of the separator plate 1. The second plate 20 is designed as a sealing plate and its primary function is to seal off a region of the separator plate 1 with respect to the surrounding environment or within the system. The region to be sealed off by the sealing element 21 may comprise the flow field 11 of the first plate. The sealing element 21 may also be arranged around the port openings 46, 47—e.g. media passages such as media supply lines or media discharge lines—so that the port openings 46, 47 are also sealed off by the sealing element 21. Furthermore, the second plate 20 has sealing elements 51 around the through-openings 50 for sealing off a second region.

The first plate 10 and the second plate 20 may both be made from sheets of metal, but differ from each other in at least one material property and/or in their material thicknesses. The different functions—namely media guidance and sealing—can thus be implemented by different materials and/or material thicknesses.

Said material property may comprise a modulus of elasticity, a strength such as a tensile strength, an electrical conductivity, a corrosion resistance, an elongation at break and/or a chemical composition.

For example, good formability, corrosion resistance and electrical conductivity would be desirable for the media-guiding part of the separator plate 1, e.g. the first plate 10, while mechanical stability and sealing effect are important criteria for the sealing part of the separator plate 1, e.g. the second plate 20. By way of example, the first plate 10 may have a higher electrical conductivity, a greater corrosion resistance, a lower modulus of elasticity and/or a greater elongation at break than the second plate 20.

FIG. 2 shows a first plate 10 made of titanium with a high elongation at break of 35% and a low strength of 300 MPa as the flow field and, with this, a second plate 20 likewise made of titanium with a low elongation at break of 15% and a high strength of 650 MPa as the plate having the sealing element.

A plate body of the first plate 10 may be made of stainless steel. Alternatively, titanium is also possible. A plate body of the second plate 20 may likewise be made of titanium or stainless steel. If both plate bodies comprise the same metals, these may be present in different quantity ratios or alloys and/or may have been processed differently.

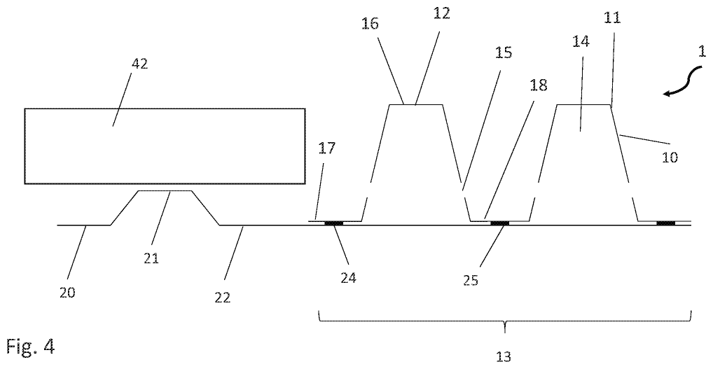

In the embodiments of FIGS. 4-5 and 7, the first plate 10 and the second plate 20 may have an identical or similar material thickness of, for example, at least 0.1 mm and/or at most 0.6 mm. Alternatively, material thicknesses that differ from each other are also possible. However, the materials of the first plate 10 and the second plate 20 differ from each other.

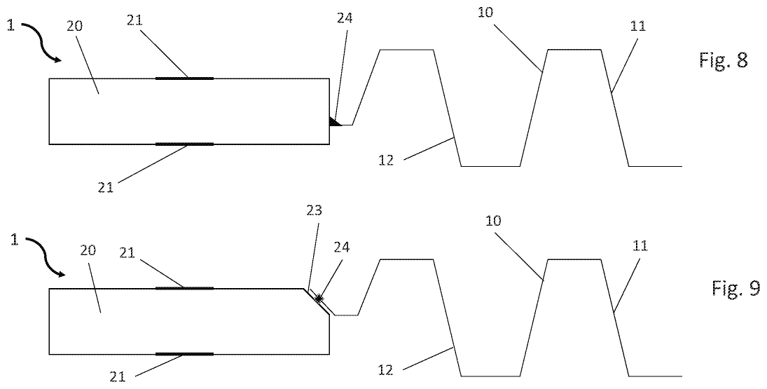

In the embodiments of FIGS. 8-10, the first plate 10 and the second plate 20 may be made of identical or different materials, but they noticeably differ from each other at least in their material thicknesses. While the material thickness of the first plate 10 is between 0.1 and 0.4 mm, for example, the material thickness of the second plate 20 of at least 0.8 mm is significantly greater.

Furthermore, the first plate 10 and the second plate 20 are connected to each other in a materially bonded manner. The materially bonded connection may comprise a welded joint such as a weld seam 24, cf. FIGS. 3-10, and/or a welded joint 25, cf. FIGS. 3-5. By way of example, the first plate 10 and the second plate 20 are connected to each other by means of spot welding, ultrasonic welding, electrode welding or laser welding. The weld seam 24 may be arranged around the flow field 11 in order to connect the two plates 10, 20 to each other at that location. For example, in the embodiments of FIGS. 6-10, the weld seam 24 is designed as a frame-like, uninterrupted weld seam. As an alternative or in addition, the plates may be connected to each other by means of a plurality of spaced-apart welded joints 25, see the exemplary embodiments of FIGS. 3-5. The spaced-apart welded joints 25 may for example be provided in the flow field 11, where the first plate 10 comes into contact with the second plate 20 in the region of the channel bottom 18.

In FIGS. 3-5, the first plate 10 and the second plate 20 overlap in the region of the channel structures 12 of the first plate 10. In the region of overlap 13, the second plate 20 may extend as a flat, continuous, closed plate and may come into contact with channel bottoms 18 of the of the first plate 10. The contact areas between the channel bottoms 18 and the second plate 20 thus form suitable locations for the above-mentioned welded joints 25 and 24.

In the region of overlap 13 and in the region of the flow field 11, there may be a cavity 14 between the first plate 10 and the second plate 20. Pressure-equalizing openings 15 may be provided in the channel structures 12 in order to fluidically connect the cavity 14 to a side 16 of the first plate 10 facing away from the second plate 20. Following production of the separator plate 1, the pressure in the cavity 14 is usually around 1 bar. The amount of gas, usually air, remaining in the cavity 14 may then remain approximately constant, if the weld seam 24 runs sealingly all the way round and no pressure-equalizing openings 15 are provided. This may be problematic if the first plate 10 is arranged on the high-pressure side of the separator plate 1, e.g. for example the hydrogen side, where the pressure may be up to 40 bar during operation of the electrochemical cell 100. The pressure-equalizing openings 15 can thus equalize this pressure difference.

It can be seen in FIGS. 3-5 that the second plate 20 has a frame-like border region 22 which extends around the circumferential edge 17 of the first plate 10, wherein the sealing element 21 is arranged in the frame-like border region 22. An orthogonal projection of the border region 22 onto a separator plate plane thus defines the circumferential edge 17 of the first plate 10, so that the border region 22 of the second plate 20 therefore has no overlap with the first plate 10. In the embodiments of FIGS. 4-5 and 7, the sealing element 21 is designed as a sealing bead integrally formed in the second plate. The sealing bead 21 may be integrally formed in the second plate by means of hydroforming, embossing and/or deep-drawing. The sealing bead may project out of a flat surface plane of the second plate 20 and may have, for example, a bead top and two bead flanks, wherein the bead top forms a bearing area for the cell frame 42. To improve its sealing function, the sealing bead 21 may also have a coating on its bead top.

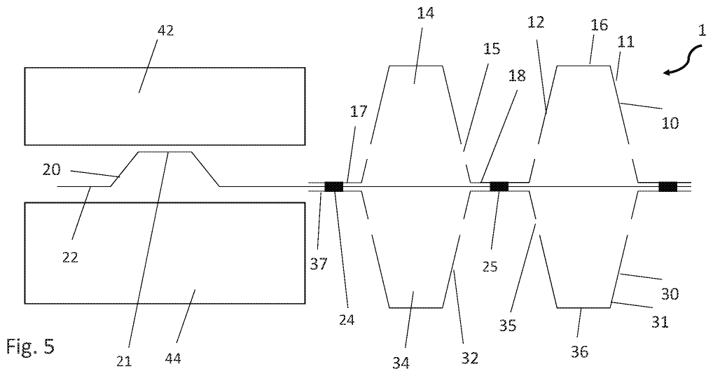

In addition to the first plate 10 and the second plate 20, the separator plate may comprise a third metal plate 30, cf. FIG. 5. The second plate 20 extends between the first plate 10 and the third plate 30. In this case, the separator plate 1 is therefore designed as a three-layer metal plate. The features of the first plate 10 and the second plate 20 of FIG. 5 do not differ from the features of the first plate 10 and the second plate 20 of FIG. 4 and therefore the description of these features will not be repeated here. The third plate 30 may be symmetrical to the first plate 10, with the first plate 10 and the third plate 30 being arranged symmetrically to each other in relation to a flat surface plane of the second plate 20. Alternatively, the third plate 30 may also differ from the first plate 10, for example in order to be better able to take account of different pressures on the high-pressure side and the low-pressure side of the separator plate 1.

In a manner analogous to the first plate 10, the third plate comprises a flow field 31 with channel structures 32 for guiding a product medium or reaction medium along a flat side of the third plate 30, pressure-equalizing openings 35, and a circumferential edge 37 which is connected to the second plate via a weld seam 24. The pressure-equalizing openings 35 are provided in order to fluidically connect the cavity 34 to a side 36 of the third plate 30 facing away from the second plate 20. A single weld seam 24 may connect the three plates 10, 20, 30 to each other. Alternatively, two weld seams 24 may be provided, wherein the first weld seam connects the plates 10, 20 to each other and the second weld seam connects the plates 20, 30 to each other. Analogously, each welded joint 25 may connect all three plates 10, 20, 30 to each other. Welded joints 25 which connect only plates 10, 20 or plates 20, 30 to each other may also be provided.

The material properties of the first plate 10 and of the third plate 30 may be identical, but may also be different. The material thicknesses of the first plate 10 and of the third plate 30 may be identical, but may also be different. The embodiment of the first plate 10 and of the third plate 30 may be identical, but may also be different.

The third plate 30 and the second plate 20 differ from each other in at least one material property and/or in their material thicknesses. With regard to the material properties and material thicknesses of the third plate 30, reference is made to what has been stated above in relation to the first plate 10.

It should also be noted that the flow directions of the media flowing on both flat sides of the separator plate 1, for example on the side of the first plate 10 and on the side of the third plate 30, such as in the region of the flow fields 11, 31, may be the same or different on both sides. If the flow directions are different, the separator plate 1 may be designed, for example, as a counter-flow plate, in which the flow directions are rotated through 180º in relation to each other, or as a cross-flow plate, in which the flow directions are rotated through, for example, 90° in relation to each other. This can also apply to the exemplary embodiments in which there is no third plate 30, cf. for example FIGS. 4 and 7-10.

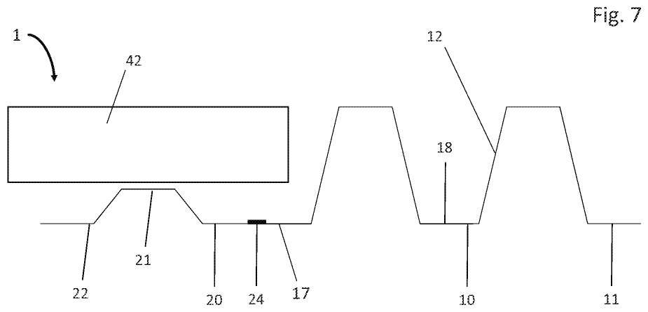

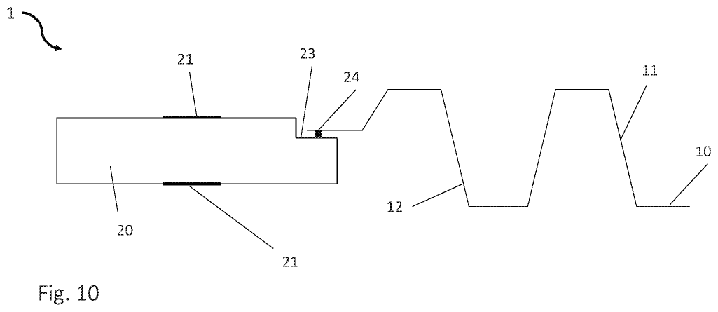

In the exemplary embodiments of FIGS. 6-10, the first plate 10 and the second plate 20 do not overlap in the region of the channel structures 12 of the first plate 10. In these embodiments, the second plate 20 may be frame-like and the first plate 10 may terminate in the outward direction at its circumferential edge 17. The second plate 20 may thus also act as a cell frame. Components can therefore be saved in this case. The first plate 10 may then be inserted as an insert part into the frame-like second plate 20. To ensure that no fluids can pass from one flat side of the separator plate 1 to the other flat side of the separator plate 1, the weld seam 24 extending all the way around in an uninterrupted manner sealingly connects the two plates 10 and 20 to each other. As a result, there is no need for additional sealing layers. The first plate 10 and the second plate 20 may be welded in an abutting (cf. FIGS. 7, 8) or overlapping manner (cf. FIGS. 9, 10). In order on the one hand to provide space for the first plate 10 and on the other hand to provide a good welding location, the second plate 20 may have a depression 23, wherein the first plate 10 is arranged in the region of the depression 23 and is welded to the second plate 20 at this location.

Furthermore, the second plate 20 may have at least one sealing element 21 which is designed as a coating or elastomer bead and is bonded to the plate body of the second plate 20. In the exemplary embodiments shown in FIGS. 8-10, sealing elements 21 are provided on both flat sides of the second plate 20. In this case, the two sealing elements 21 may be different in terms of type, geometry and course.

In FIGS. 6-10, channel structures 12 are provided on both sides of the first plate 10 in the flow field 11. The flow field 11 can therefore be used on both sides—for instance on the high-pressure side and the low-pressure sides—for the media distribution of fluids.

The following features may also be implemented for all the embodiments described above. For instance, the flow field 11 of the first plate 10 and/or the flow field 31 of the third plate 30 (if provided) may form a support surface for the above-described membrane electrode assembly 40 of the electrochemical cell 100. As indicated in FIG. 1, a media diffusion structure 41, 43, such as a gas diffusion layer or a porous transport layer, may optionally also be arranged between the membrane electrode assembly 40 and the flow field 11 and/or 31. Said flow fields 11, 31 or the channel structures 12, 32 thereof may be integrally formed in the first plate 10 by means of hydroforming, embossing and/or deep-drawing. In addition, the separator plate 1 may be designed as a bipolar plate.

Depending on the requirements and the application, coatings may also be applied to the metal plate bodies of the plates 10, 20, for example in order to improve the conductivity, the corrosion resistance or the microsealing effect.

It should also be noted that the electrochemical system described in the present specification is not limited to an electrolyser. The electrochemical system may alternatively also be a fuel cell system or a redox flow battery. In embodiments in which the electrochemical system is an electrolyser, water is often the reaction medium, while hydrogen and oxygen may be the product medium. In a fuel cell system, hydrogen and oxygen are often the reaction media, while water is the product medium.

As an alternative or in addition to the welded joints 24, 25, the plates 10, 20 may be soldered to each other. The reference signs 24, 25 shown in FIGS. 3-10 may in this case represent soldered joints.

Individual features of the separator plates 1 and assemblies described above and shown in FIGS. 1-10 may be claimed separately or combined with each other, provided that the features being combined do not contradict each other.

FIGS. 1-10 are shown approximately to scale. FIGS. 1-10 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, the separator plate comprising:
a first metal plate, the first plate having a flow field with channel structures integrally formed in the first plate, the flow field guiding a reaction medium or product medium along the first plate,
a second metal plate having at least one sealing element for sealing off at least one region of the separator plate,
wherein the first plate and the second plate differ from each other in at least one material property and/or in their material thicknesses,
wherein the first plate and the second plate are connected to each other in a materially bonded manner.

2. The separator plate according to claim 1, wherein said material property comprises a modulus of elasticity, a strength, an electrical conductivity, a corrosion resistance, an elongation at break and/or a chemical composition.

3. The separator plate according to claim 1, wherein a material thickness of the first plate is between 0.1 and 0.6 mm, and/or wherein a material thickness of the second plate is between 0.1 and 1.2 mm.

4. The separator plate according to claim 1, wherein the first plate and the second plate overlap in the region of the channel structures of the first plate.

5. The separator plate according to claim 4, wherein the second plate is a continuous, closed plate at least in the region of overlap with the first plate.

6. The separator plate according to claim 4, wherein a cavity is defined between the first plate and the second plate in the region of the flow field, wherein pressure-equalizing openings are provided in the channel structures in order to fluidically connect the cavity to a side of the first plate facing away from the second plate.

7. The separator plate according to claim 4, wherein the second plate has a frame-like border region which extends around the circumferential edge of the first plate, wherein the sealing element is arranged in the frame-like border region.

8. The separator plate according to claim 1, comprising a third metal plate which has a flow field with channel structures which guide a product medium or reaction medium along the third plate, wherein the second plate is arranged between the first plate and the third plate,
wherein the third plate and the second plate differ from each other in at least one material property and/or in their material thicknesses, and
wherein the third plate and the second plate are connected to each other in a materially bonded manner.

9. The separator plate according to claim 8, wherein the first plate and the third plate are made of the same material and/or have the same material thickness.

10. The separator plate according to claim 1, wherein the first plate and the second plate do not overlap in the region of the channel structures of the first plate.

11. The separator plate according to claim 1, wherein the second plate is frame-like and the first plate terminates in the outward direction at its circumferential edge, wherein the first plate is inserted into the frame-like second plate.

12. The separator plate according to claim 1, wherein the first plate and the second plate are welded in an abutting or overlapping manner.

13. The separator plate according to claim 1, wherein the second plate has a depression, and the first plate is connected to the second plate in the region of the depression.

14. The separator plate according to claim 1, wherein a plate body of the first plate and/or a plate body of the second plate are made of stainless steel and/or titanium.

15. The separator plate according to claim 1, wherein the first plate and the second plate are welded to each other by one or more of spot welding, roller welding, electrode welding or laser welding.

16. The separator plate according to claim 1, wherein the flow field of the first plate forms a support surface for a membrane electrode assembly of an electrochemical cell.

17. The separator plate according to claim 1, wherein the sealing element comprises a sealing bead integrally formed in the second plate, or an elastomer bead or coating bonded to a plate body of the second plate, and
wherein the sealing element seals off the flow field and/or the media passages.

18. An assembly for an electrochemical system, comprising a separator plate according to claim 1, a membrane electrode assembly (MEA) arranged on the flow field side of the first plate, and/or a media diffusion structure arranged between the MEA and the flow field.

19. The assembly according to claim 17, comprising a cell frame which is arranged around the first plate and is arranged on the sealing element of the second plate.

20. An electrochemical system, comprising a plurality of stacked separator plates according to claim 1 or a plurality of assemblies.
